(19) United States
(12) Patent Application Publication
(10) Pub. No.: US 2018/0023629 A1
(43) Pub. Date: Jan. 25, 2018

(54) PROPELLER SHAFT

(71) Applicant: HITACHI AUTOMOTIVE SYSTEMS, LTD., Hitachinaka-shi (JP)

(72) Inventors: Kenichi SUGIYAMA, Commerce Township, MI (US); Yasutomo MABE, Atsugi-shi (JP)

(73) Assignee: HITACHI AUTOMOTIVE SYSTEMS, LTD., Hitachinaka-shi (JP)

(21) Appl. No.: 15/656,609

(22) Filed: Jul. 21, 2017

(30) Foreign Application Priority Data
Jul. 25, 2016 (JP) 2016-145148

(51) Int. Cl. F16D 1/116; F16D 3/226; F16D 1/06

(52) U.S. Cl. CPC F16D 1/116; F16D 1/06; F16D 3/226; F16D 2001/103

(57) ABSTRACT

Disclosed is a propeller shaft including a shaft portion; a joint portion provided between the shaft portion and a rotating shaft; a sleeve portion provided at the joint portion and having an inner peripheral side for receiving therein the rotating shaft; a through hole formed through a circumferential range of the sleeve portion, the through hole being opposed in a radial direction of the sleeve portion to an engaging groove formed on an outer peripheral side of the rotating shaft in a condition that the sleeve portion receives therein the rotating shaft; and a circlip provided on an outer peripheral side of the sleeve portion, the circlip being engaged in the engaging groove of the rotating shaft through the through hole of the sleeve portion. In this propeller shaft, the engaging condition of the circlip can be observed from outside

### TECHNICAL FIELD

The present invention relates to a propeller shaft (drive shaft), which is applied, for example, to automobiles to transmit the driving force of a driving source to a driving wheel.

### BACKGROUND OF THE INVENTION

As a conventional propeller shaft, there is known one described in U.S. Pat. No. 8,864,591 B2, corresponding to Japanese Patent Application Publication 2013-194895.

This propeller shaft is connected on its one end side in the axial direction to a first shaft on the driving source side and on the other end side to a second shaft on the driving wheel side through respective constant velocity joints. Each shaft is connected to each constant velocity joint by engaging a circlip (snap ring) fitted on the outer peripheral side of each shaft in an annular engaging groove formed as a cutout on the inner peripheral side of each constant velocity joint.

### SUMMARY OF THE INVENTION

Since the above-mentioned conventional propeller shaft has a structure in which the circlip is engaged in the engaging groove on the inner peripheral side of each constant velocity joint, it is not possible to check the engaging condition of the circlip from outside. This may interfere with a proper assembly of the propeller shaft.

Therefore, the present invention was made in view of the technological task of the above-mentioned convention propeller shaft, and it is an object of the present invention to provide a propeller shaft in which the engaging condition of the circlip can be observed from outside.

According to the present invention, there is provided a propeller shaft that is provided between a driving source and a driving wheel of a vehicle to transmit rotation of the driving source to the driving wheel, the propeller shaft comprising:

a shaft portion interposed between a first shaft on a side of the driving source and a second shaft on a side of the driving wheel;

a joint portion provided between the shaft portion and a rotating shaft that is one of the first and second shafts;

a sleeve portion that is provided at the joint portion and has an inner peripheral side for receiving therein the rotating shaft;

a through hole that is formed through a circumferential range of a portion of the sleeve portion, the through hole being opposed in a radial direction of the sleeve portion to an engaging groove formed on an outer peripheral side of the rotating shaft in a condition that the sleeve portion receives therein the rotating shaft on the inner peripheral side of the sleeve portion; and

a circlip provided on an outer peripheral side of the sleeve portion, the circlip being engaged in the engaging groove of the rotating shaft through the through hole of the sleeve portion.

### Advantageous Effect of the Invention

According to the present invention, the rotating shaft (i.e., one of the first and second shafts) is locked in the sleeve portion of the propeller shaft in a manner that the circlip is fitted on the sleeve portion from outside. Therefore, the engaging condition of the vehicle-side rotating shaft by the circlip can be checked from outside. This makes it possible to secure a proper locking of the rotating shaft by the circlip.

### BRIEF DESCRIPTION OF THE DRAWINGS

FIG. 1 is a side view showing a propeller shaft according to the present invention;

FIG. 2 is an enlarged view showing an essential part of an input or output shaft shown in FIG. 1;

FIG. 3 is a longitudinal sectional view showing a condition in which the input shaft has been inserted into an inner race member of a first constant-velocity joint shown in FIG. 1;

FIG. 4 is a perspective view showing around a sleeve portion of a second constant-velocity joint shown in FIG. 1;

FIG. 5 is a view similar to FIG. 4, but showing a partially longitudinal sectional view;

FIG. 6 is a sectional view taken along lines 6-6 in FIG. 5;

FIG. 7 is a longitudinal sectional view showing a condition in which the output shaft has been inserted into a sleeve portion of the second constant-velocity joint shown in FIG. 1;

FIG. 8 is a sectional view taken along lines 8-8 in FIG. 7;

FIG. 9 is a plan view showing a circlip in FIG. 8;

FIG. 10 is a view similar to FIG. 8, but showing a temporary engagement condition of the circlip;

FIG. 11 is a perspective view showing a jig in FIG. 10;

FIG. 12A is a perspective view showing a condition prior to a connection between the propeller shaft and the output shaft;

FIG. 12B is a sectional view taken along lines 12B-12B in FIG. 12A;

FIG. 13A is view similar to FIG. 12A, but showing a condition in which the connection between the propeller shaft and the output shaft has been completed;

FIG. 13B is a sectional view taken along lines 13B-13B in FIG. 13A;

FIG. 14 is a view similar to FIG. 8, but showing an engaging condition by a circlip according to the second embodiment of the present invention; and

FIG. 15 is a plan view showing the circlip in FIG. 14

### DETAILED DESCRIPTION

In the following, an embodiment of a propeller shaft according to the present invention is described in detail with reference to the drawings. In the following embodiment, the propeller shaft is applied to an automotive propeller shaft, similar to the above-mentioned conventional one.

### First Embodiment

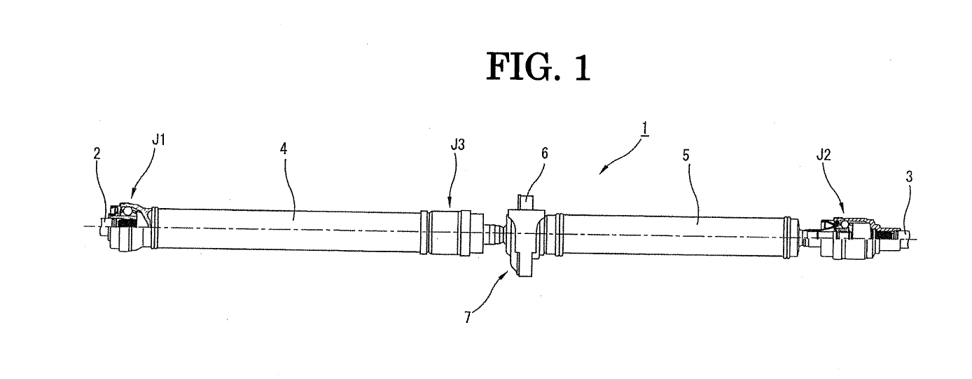

FIGS. 1 to 13B show the first embodiment of a propeller shaft 1 according to the present invention. FIG. 1 is a side view showing the propeller shaft 1 as a whole. In the following description, as a matter of convenience, the left and right sides of FIG. 1 are respectively defined as front and back, a direction along the rotation center axis of the propeller shaft 1 in FIG. 1 is defined as the axial direction, and a direction along the circumference of the rotation center axis the propeller shaft 1 in FIG. 1 is defined as the circumferential direction.

(Construction of Propeller Shaft)

This propeller shaft 1 is equipped with (a) a drive shaft 4 that is connected to an input shaft 2, which is linked to a transmission not shown in the drawings, via a first constant-velocity joint J1 in a manner to provide an integral rotation (i.e., synchronized rotation) therebetween, and (b) a driven shaft 5 that is connected to an output shaft 3, which is linked to a differential not shown in the drawings, via a second constant-velocity joint J2 in a manner to provide an integral rotation therebetween. These drive and driven shafts 4, 5 are connected with each other via a third constant-velocity joint J3 in a manner to provide an integral rotation therebetween and are rotatably supported via a center bearing 7, which is provided in the vicinity of this third constant-velocity joint J3 and is suspended from a vehicle body not shown in the drawings via a known bracket 6. The drive and driven shafts 4, 5 constitute a shaft portion according to the present invention. The first to third constant-velocity joints J1 to J3 constitute joints according to the present invention.

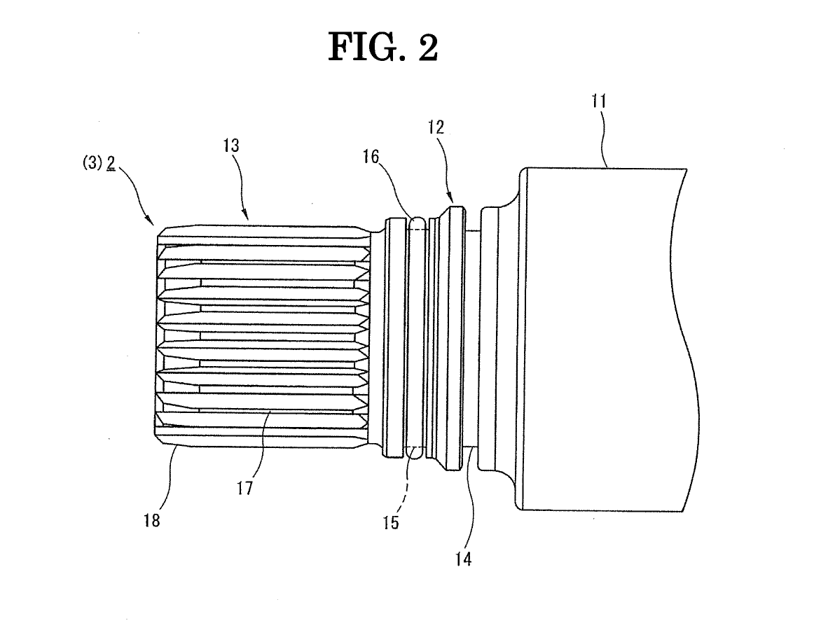

FIG. 2 is an enlarged view showing an essential part of the input or output shaft 2, 3 shown in FIG. 1, and this essential part is an end portion of the input or output shaft 2, 3 that is connected with the propeller shaft 1.

The input or output shaft 2, 3 is mainly constructed of a large-diameter portion 11 that is linked to the transmission or differential, a medium-diameter, stepped-shape portion 12 that is integrally provided on an end portion of the large-diameter portion 11, and a small-diameter portion 13 that is integrally provided on an end portion of the medium-diameter portion 12.

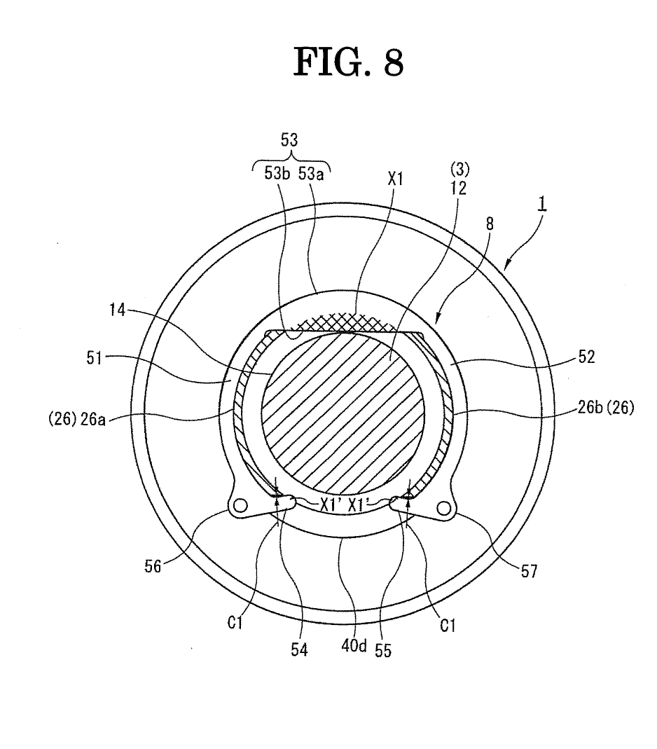

The medium-diameter portion 12 is formed on the side of the large-diameter portion 11 with an annular engaging groove 14 that is formed as a cutout in the circumferential direction, such that a circlip 8 (see FIG. 8) is engaged therein to retain the input or output shaft 2, 3 when the input shaft 2 and the first constant-velocity joint J1 are in a connected condition or when the output shaft 3 and the second constant-velocity joint J2 are in a connected condition.

On the other hand, the medium-diameter 12 is formed on the side of the small-diameter portion 13 with a sealing groove 15 that is formed as a cutout in the circumferential direction, and this sealing groove 15 has a sealing member 16 fitted therein to suppress penetration of water, etc. into the first or second constant-velocity joint J1, J2.

The small-diameter portion 13 is formed on its entire outer peripheral surface with male splines 17 formed in the axial direction. This small-diameter portion 13 is formed at its end portion with a tapered portion 18 for an easy guide into the after-mentioned sleeve portion 40.

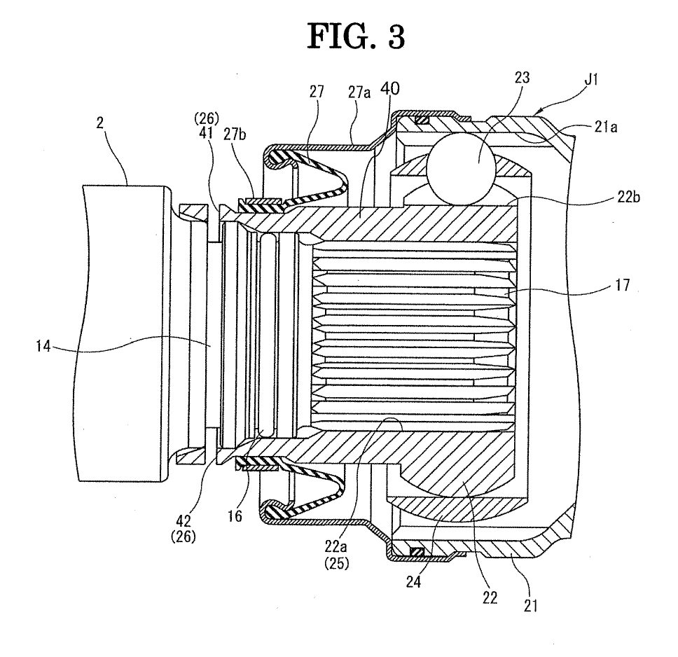

FIG. 3 is a longitudinal sectional view showing a condition in which the input shaft 2 has been inserted into the first constant-velocity joint J1.

The first constant-velocity joint J1 is mainly constructed of (a) an outer race member 21 having one end in the axial direction to be connected to the driving shaft 4, (b) an inner race member 22 that is arranged on the inner peripheral side of the outer race member 21 and receives the driving torque from the input shaft 2, and (c) balls 23 as a plurality of rolling elements that are rotatably interposed between the inner and outer race members 22, 21 and are retained by a retainer 24.

The outer race member 21 is shaped like a cup to be opened on the other end side in the axial direction. Ball engaging grooves 21a as axial grooves are formed as cutouts on the inner peripheral side of the outer race member 21 to be straight along the axial direction, such that a relative movement between the outer race member 21 and the inner race member 22 in the axial direction is allowed by the rolling motion of each ball 23, but a relative movement therebetween in the circumferential direction is limited by the engagement of each ball 23 therein.

The inner race member 22 is almost cylindrical in shape and has (a) an insertion hole 22a that is formed therethrough in the inner axial direction, (b) female splines 25 that are formed as cutouts in the axial direction on the inner peripheral side of the insertion hole 22a to be mated with the male splines 17 of the input shaft 2 in the axial direction, and (c) ball engaging grooves 22b that are formed to be straight in the axial direction as cutouts on the outer peripheral side of the inner race member 22 for allowing the rolling motion of respective balls 23 thereon. These ball engaging grooves 22b are axial grooves similar to the ball engaging grooves 21a of the outer race member 21.

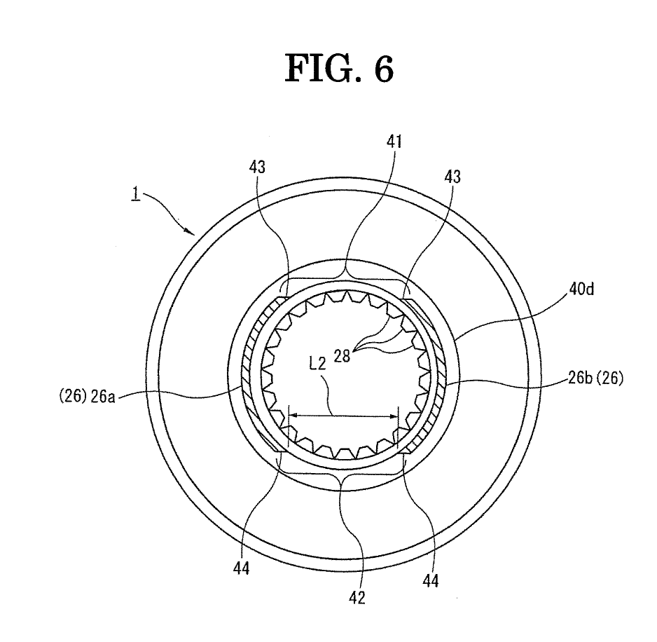

In the vicinity of the front end of the inner race member 22, an annular retaining groove 26 is formed as a cutout in the circumferential direction to retain the circlip 8 therein. This retaining groove 26 is partly formed in the circumferential direction with a pair of first and second through holes 41, 42 that are opposed to each other in the diametral direction (the vertical direction in FIG. 6) and are brought into a position to be opposed to the engaging groove 14 of the input shaft 2 in the radial direction in a condition where the input shaft 2 has been inserted in the insertion hole 22a of the inner race member 22, thereby exposing the engaging groove 14 of the input shaft 2 to the outside.

The retaining groove 26 and the first and second through holes 41, 42 are similar to those provided at the after-mentioned sleeve portion 40 of the second constant-velocity joint J2. Therefore, their specific structures are described hereinafter together with the description of the after-mentioned sleeve portion 40.

A water-proof boot 27 is installed between the outer and inner race members 21, 22 to stretch therebetween for the purpose of protecting the first constant-velocity joint J1 from water, dust, etc. This water-proof boot 27 is formed to be flexible in the axial direction by having a bent portion at its middle portion, and has one end in the axial direction that is fixed by swaging to the outer peripheral surface at the front end side of the outer race member 21 through a metal clamp 27a and the other end that is bindingly fixed to the outer peripheral surface at the front end side of the inner race member 22 through a band member 27b.

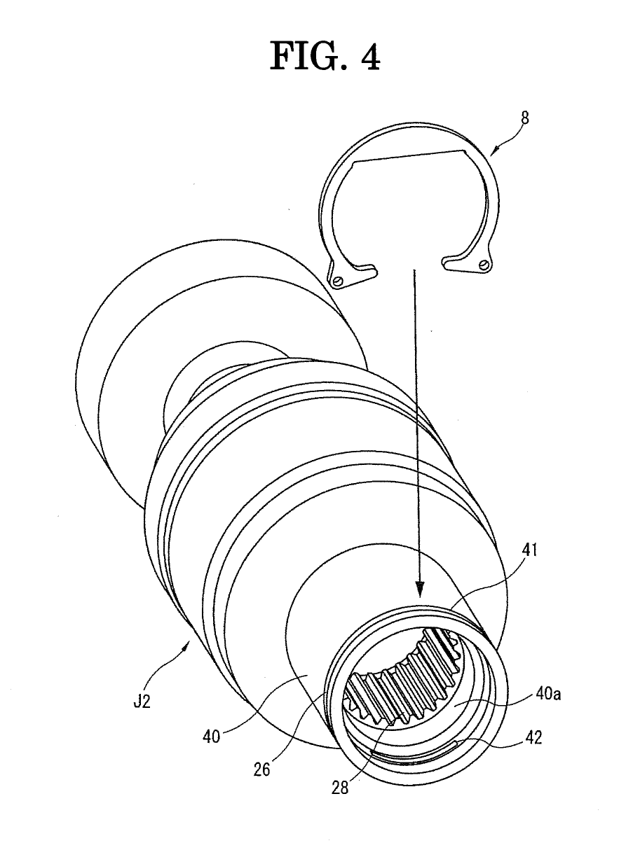

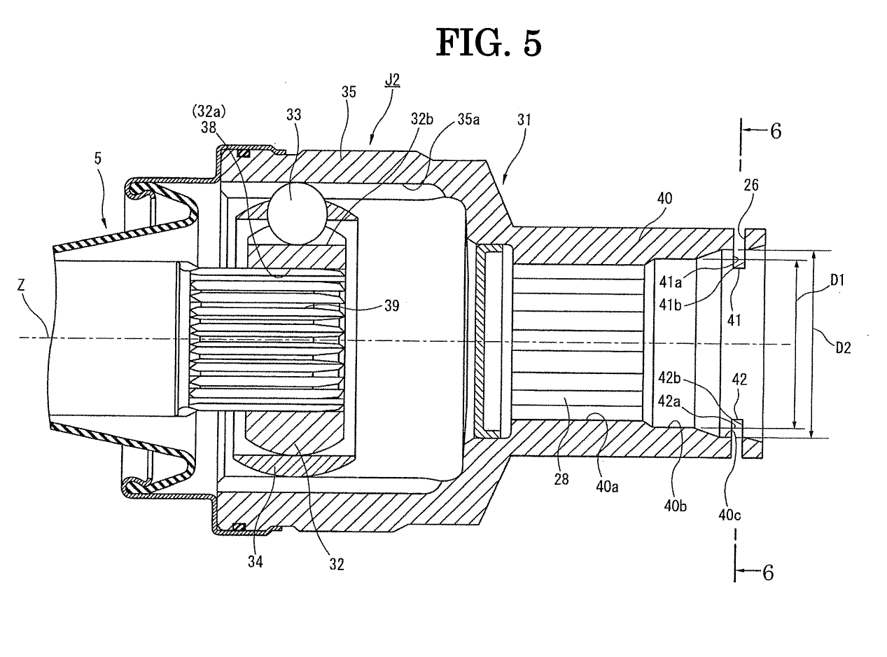

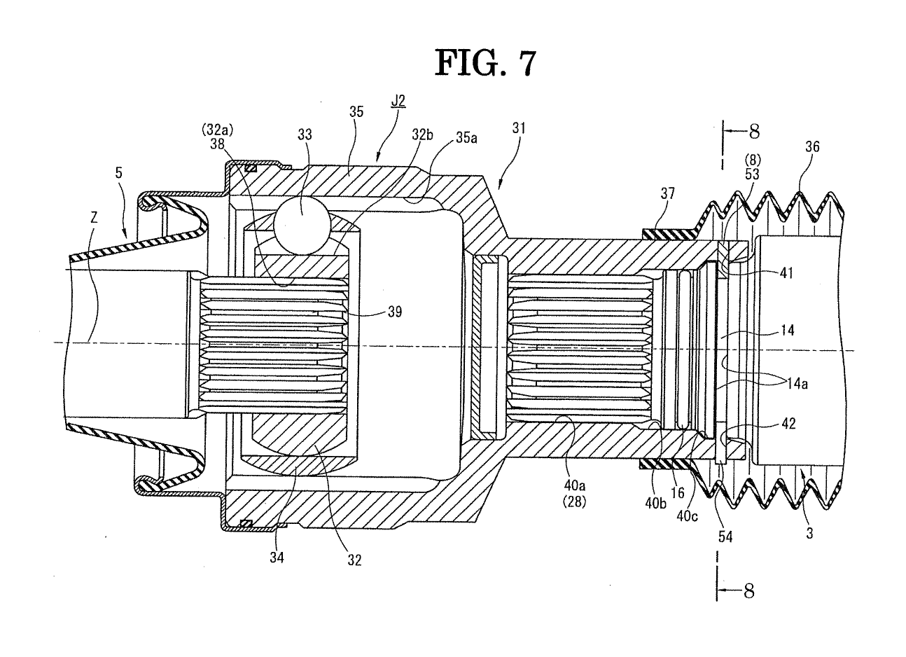

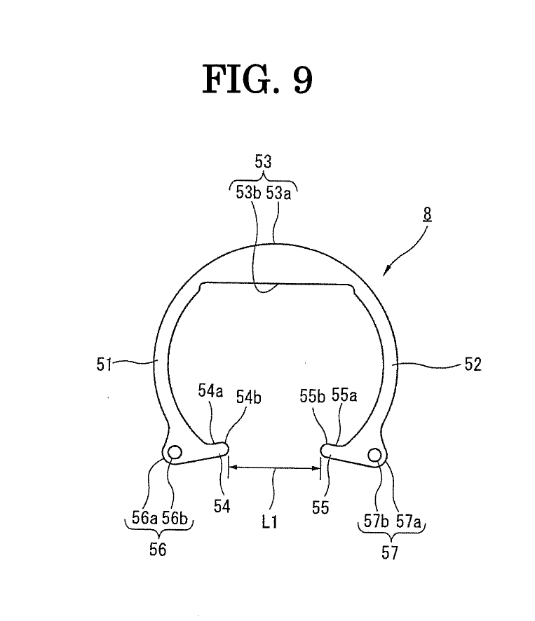

FIG. 4 is a perspective view showing around the sleeve portion 40 of the second constant-velocity joint J2. FIG. 5 is a view similar to FIG. 4, but showing a partially longitudinal sectional view. FIG. 6 is a sectional view taken along lines 6-6 in FIG. 5. FIG. 7 is a longitudinal sectional view showing a condition in which the output shaft 3 has been inserted into the sleeve portion 40 of the second constant-velocity joint J2. FIG. 8 is a sectional view taken along lines 8-8 in FIG. 7. FIG. 9 is a plan view showing the circlip 8 in FIG. 8.

The second constant-velocity joint J2 is linked to the driven shaft 5 at its one end in the axial direction and is mainly constructed of (a) an outer race member 31 constituting an outer race of this joint, (b) an inner race member 32 that is arranged on the inner peripheral side of the outer race member 31 and transmits the driving torque of the driven shaft 5 to the output shaft 3, and (c) balls 33 as a plurality of rolling elements that are rotatably interposed between the inner and outer race members 32, 31 and are retained by a retainer 34.

The outer race member 31 is generally cylindrical in shape and is formed on its one end side with a large-diameter outer race portion 35 extending toward the driven shaft 5 and on the other end side with a sleeve portion 40 that is smaller than the outer race portion 35 in diameter and extends toward the output shaft 3 along the rotation center axis Z.

The outer race portion 35 is shaped like a cup to be opened on one end side in the axial direction. Ball engaging grooves 35a as axial grooves are formed as cutouts on the inner peripheral side of the outer race portion 35 to be straight along the axial direction, such that a relative movement between the outer race member 31 and the inner race member 32 in the axial direction is allowed by the rolling motion of each ball 33, but a relative movement therebetween in the circumferential direction is limited by the engagement of each ball 33 therein.

The sleeve portion 40 has (a) an insertion hole 40a that is formed therethrough in the inner axial direction and (b) female splines 28 that are formed as cutouts in the axial direction on the inner peripheral side of the insertion hole 40a to be mated with male splines 17 of the output shaft 3 in the axial direction.

As is seen from FIG. 5, the sleeve portion 40 is formed on its rear end side from the female splines 28 with a stepped expanding portion, and this stepped expanding portion has (a) a sealing abutment portion 40b that is formed to be slightly larger than the maximum diameter of the female splines 28 and to make it possible a resilient abutment of a sealing member 16 fitted on the output shaft 3 against the sealing abutment portion 40b and (b) a shaft fixing portion 40c that is formed to be slightly larger than the sealing abutment portion 40b and is used for the engaging fixing of the output shaft 3 by the circlip 8. Inner diameter D1 of the sealing abutment portion 40b is formed to be smaller than inner diameter D2 of the shaft fixing portion 40c.

Furthermore, on the outer peripheral side of the shaft fixing portion 40c of the sleeve portion 40, an annular retaining groove 26 is formed as a cutout in the circumferential direction to retain the circlip 8 therein. This retaining groove 26 is partly formed in the circumferential direction with a pair of first and second through holes 41, 42 that are opposed to each other in the diametral direction and are brought into a position to be opposed to the engaging groove 14 of the output shaft 3 in the radial direction in a condition where the output shaft 3 has been inserted in the insertion hole 40a of the sleeve portion 40, thereby exposing the engaging groove 14 of the output shaft 3 to the outside. In other words, in an annular range in the circumferential direction where the first and second through holes 41, 42 are provided, a part not provided with the first and second through holes 41, 42 is defined as the retaining groove 26.

As is seen from FIG. 6, the retaining groove 26 is constituted of a pair of retaining grooves 26a, 26b extending in a pair of circumferential regions each being positioned between the first and second through holes 41, 42. These retaining grooves 26a, 26b are symmetrical with respect to the rotation center axis Z (see FIG. 5).

As is seen from FIGS. 4 and 6, the first and second through holes 41, 42 are formed by partially cutting out two respective arcuate bottom portions of the retaining groove 26 (see FIG. 4), such that these through holes 41, 42 are separate from each other in the circumferential direction and are opposed to each other to be symmetrical with respect to the rotation center axis Z.

As is seen from FIG. 6, the above partial cutting out for forming the first and second through holes 41, 42 is conducted, such that there is provided a pair of first flat surfaces 43, 43 along a horizontal direction in FIG. 6 at both ends of the first through hole 41 in the circumferential direction and that there is similarly provided a pair of second flat surfaces 44, 44 therealong at both ends of the second through hole 42 in the circumferential direction.

As is seen from FIGS. 2 and 5, in a condition where the output shaft 3 has been inserted into the sleeve portion 40 of the second constant-velocity joint J2, the first and second through holes 41, 42 are opposed to and joined with the engaging groove 14 of the output shaft 3, such that there are provided first side surfaces 41a, 41b and second side surfaces 42a, 42b, which are formed on both ends of the through holes 41, 42 in the axial direction, parallel with each other, and perpendicular to the rotation center axis Z.

As is seen from FIG. 7, a water-proof boot 36 as a cover member for suppressing penetration of water, dust, etc. through the first and second through holes 41, 42 is installed on the sleeve portion 40 in a manner to stretch between the sleeve portion 40 and the output shaft 3 to cover the first and second through holes 41, 42. This water-proof boot 36 is formed to be capable of expansion and contraction in the axial direction by having a bellows portion at its middle portion and is attached to a boot attaching portion 37 at a position that is on the outer periphery of the sleeve portion 40 and is opposite to the insertion hole of the output shaft 3 in the axial direction with respect to the first and second through holes 41, 42 toward the outer race portion 35.

As is seen from FIGS. 5 and 7, the inner race member 32 is almost cylindrical in shape, has an insertion hole 32a formed therethrough in the inside axial direction, and is formed on the inner peripheral side of the insertion hole 32a with female splines 38 that are formed as cutouts in the axial direction to have an engagement with the male splines 39 of the driven shaft 5 in the axial direction. Furthermore, on the outer periphery to allow rolling motion of each ball 33, the inner race member 32 has ball engaging grooves 32b that are formed straight as cutouts in the axial direction as axial grooves similar to the ball engaging grooves 35a of the outer race member 31.

As is seen from FIG. 9, the circlip 8 is prepared by pressing a metal plate into an almost C-shape. It has (a) a pair of first and second arm portions 51, 52 each having an arcuate shape along the retaining groove 26 to be fitted into the retaining groove 26, (b) a connecting portion 53 that connects together one end portions (upper end portions in FIG. 9) of the first and second arm portions 51, 52 in the circumferential direction and is brought into engagement in the engaging groove 14 through the first through hole 41, and (c) a pair of first and second engaging portions 54, 55 that extend from the other end portions of the first and second arm portions 51, 52 and are brought into engagement with the second flat surfaces 44, 44 (see FIG. 6) of the retaining groove 26. After a complete engagement of the circlip 8 in the retaining groove 26 of the sleeve portion 40 (see FIG. 8), the circlip 8 except its first jig-engaging portions 56, 57 does not protrude from the outer peripheral surface 40d of the sleeve portion 40.

The connecting portion 53 of the circlip 8 is formed on its outer peripheral side with an arcuate surface 53a to be matched with the outer peripheral surface 40d of the sleeve portion 40 and on its inner peripheral side with a straight surface 53b to be placed on the first flat surfaces 43, 43. After the above-mentioned complete engagement, the circlip 8 projects toward the inner peripheral side of the sleeve portion 40 through the first through hole 41 and is overlapped or engaged at its arcuate meshed portion X1 (see FIG. 8) with a side wall 14a of the engaging groove 14, thereby retaining the output shaft 3.

The first and second engaging portions 54, 55 of the circlip 8 are formed by respectively inwardly bending the other end portions of the first and second arm portions 51, 52, and are brought into engagement at their inner surfaces 54a, 55a with the second flat surfaces 44, 44, thereby preventing dropping of the circlip 8. Besides, the circlip 8 projects toward the inner peripheral side of the sleeve portion 40 through the second through hole 42 and is overlapped or engaged at its two tip portions X1′, X1′ (see FIG. 8) with a side wall 14a of the engaging groove 14, thereby retaining the output shaft 3 by working together with the arcuate portion X1.

The first and second engaging portions 54, 55 of the circlip 8 are configured, such that they are not brought into abutment with the second flat surfaces 44, 44, but are brought into engagement in the retaining groove 26 to have small gaps C1 (see FIG. 8) respectively between the first and second engaging portions 54, 55 and the second flat surfaces 44, 44.

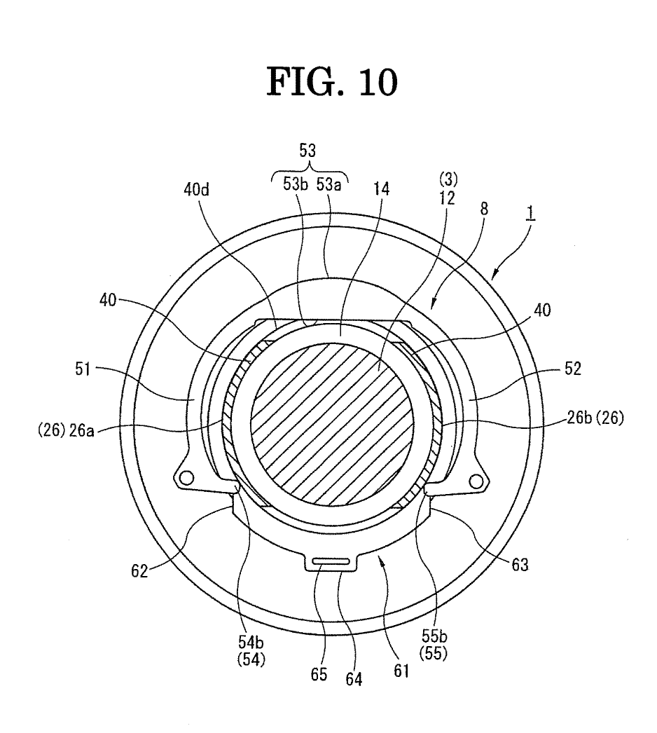

The first and second engaging portions 54, 55 of the circlip 8 are configured, such that they are respectively inwardly raised in a free state (see FIG. 9) and are flexed to an almost horizontal state (see FIG. 10) under the after-mentioned temporary engagement condition of the circlip 8 (i.e., a diameter expanded condition of the circlip 8 by a jig 61).

The first and second engaging portions 54, 55 of the circlip 8 are configured, such that the distance L1 (see FIG. 9) therebetween is made shorter than the distance L2 (see FIG. 6) between the second flat surfaces 44, 44. As shown in FIG. 6, it is optional to have the same distance between the first flat surfaces 43, 43.

The first and second engaging portions 54, 55 of the circlip 8 are formed on their outer peripheral sides with first jig-engaging portions 56, 57 that are projectingly formed, and a jig like pliers (not shown in the drawings) is brought into engagement with the first jig-engaging portions 56, 57 in order to disengage the circlip 8 from the retaining groove 26. The first jig-engaging portions 56, 57 respectively have through holes 56b, 57b that are formed through end portions of overlaid portions 56a, 57a projecting toward the outer peripheral sides of the first and second engaging portions 54, 55.

In the case of disengaging the circlip 8 to take out the input or output shaft 2, 3, the jig bifurcated like pliers is brought into engagement at its tip portions with the through holes 56b, 57b of the first and second engaging portions 54, 55, and then these engaging portions 54, 55 are expanded outward by outwardly moving the tip portions of the jig. With this, it is possible to disengage the circlip 8 from the retaining groove 26 and take the output shaft 3 out of the sleeve portion 40.

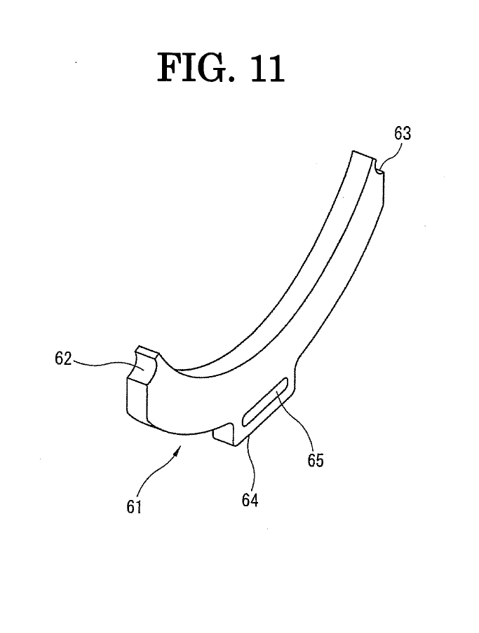

FIG. 10 is a view similar to FIG. 8, but showing a temporary engagement condition of the circlip 8 by the jig 61. FIG. 11 is a perspective view showing the jig 61 for the temporary engagement of the circlip 8.

This jig 61 has an arcuate portion having a curvature that is almost the same as that of the sleeve portion 40 and is formed at its both ends of the arcuate portion in the circumferential direction with first and second engaging portions 62, 63 (recess portions) that are capable of engagement with tip portions of the first and second engaging portions 54, 55 of the circlip 8. Furthermore, this jig 61 is formed at its bottom portion with a projection portion 64, and a predetermined tool (not shown in the drawings) is brought into engagement with a tool engagement portion 65 that is formed through the projection portion 64 to conduct engagement or disengagement of the jig 61.

On the other hand, the circlip 8 is formed at its tip portions of the first and second engaging portions 54, 55 with second jig-engaging portions 54b, 55b in order to maintain a condition where the engaging portions 54, 55 are expanded by engagement with the first and second engaging portions 62, 63 of the jig 61.

As shown in FIG. 10, it is possible to maintain the temporary engagement condition of the circlip 8 in a condition that the circlip 8 is mounted on the sleeve portion 40, by bringing the first and second engaging portions 62, 63 of the jig 61 into engagement with the second jig-engaging portions 54b, 55b of the circlip 8 to interpose the jig 61 between the first and second engaging portions 54, 55 of the circlip 8.

In other words, it is possible by using the jig 61 to bring the propeller shaft 1 into a car assembly plant in a condition that the circlip 8 has previously been mounted on the sleeve portion 40.

(Method for Achieving a Connection Between Propeller Shaft and Output Shaft)

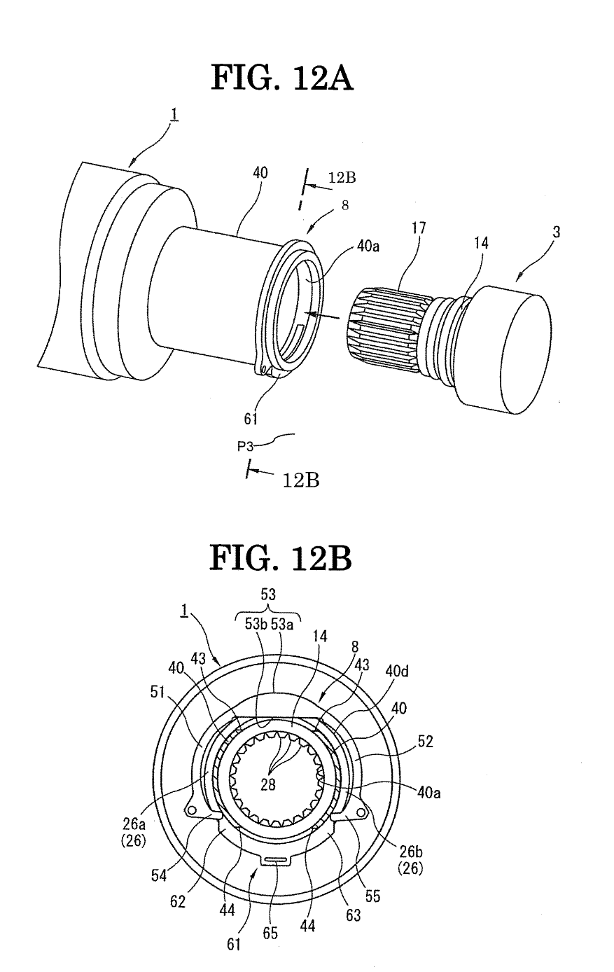

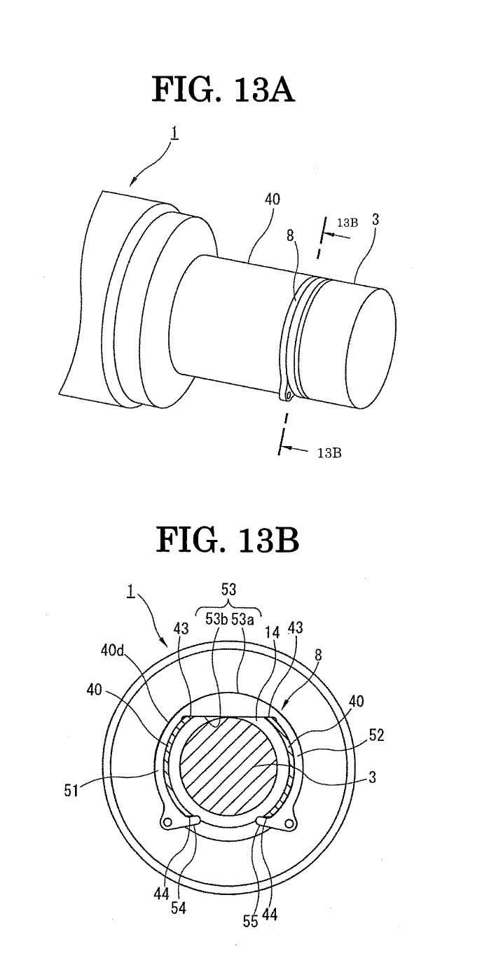

With reference to FIGS. 12A to 13B, a method for achieving a connection between the propeller shaft and the output shaft according to the present embodiment is described in the following. FIGS. 12A and 12B show a condition prior to the connection, and FIGS. 13A and 13B show a condition after completion of the connection.

Firstly, as shown in FIG. 12B, the circlip 8 in a diameter expanded condition by the jig 61 is brought into a temporary or incomplete engagement into the retaining groove 26 on the sleeve portion 40 of the second constant-velocity joint J2. Then, as shown in FIG. 12A, the output shaft 3 is inserted along the axial direction into the insertion hole 40a of the sleeve portion 40 until a proper position where the first and second through holes 41, 42 are opposed to and joined with the engaging groove 14 of the output shaft 3.

Then, the predetermined tool is brought into engagement with the tool engagement portion 65 of the jig 61 to pull out the jig 61 downwardly in FIG. 12B. With this, as shown in FIG. 13B, the circlip 8 is spontaneously brought into a complete engagement with the retaining groove 26 by resilient restoring force of the circlip 8 to return its diameter expanded shape into the original shape. Specifically, the first and second engaging portions 54, 55 move downwardly in a sliding manner along an arcuate surface of the retaining groove 26 of the sleeve 40, until they are brought into engagement with the second flat surfaces 44, 44 of the retaining groove 26 and until their tip portions X1′, X1′ (see FIG. 8) protrude into the engaging groove 14 of the output shaft 3 through the second through hole 42. Simultaneously, the connecting portion 53 of circlip 8 also moves downwardly until its arcuate portion X1 protrudes into the engaging groove 14 of the output shaft 3 through the first through hole 41. Thus, a connection between the propeller shaft 1 and the output shaft 3 is completed.

### Effects of the Present Embodiment

As mentioned above, after the complete engagement of the circlip 8 in the retaining groove 26, the engaging condition of the circlip can be observed from outside (see FIG. 13). This makes it possible to secure a proper locking of the rotating shaft (i.e., the input or output shaft 2, 3) by the circlip 8.

Furthermore, the complete engagement of the circlip 8 is achieved by inserting the circlip 8 into the engaging groove 14 through the first and second through holes 41, 42 (see FIG. 6). With this, it is possible to obtain an improved locking of the rotating shaft, as compared with a case of using a single through hole. In fact, in the present embodiment, the rotating shaft is securely locked by the above-mentioned three portions X1, X1′, X1′ of the circlip 8 (see FIG. 8).

The first and second through holes 41, 42 are symmetrical with respect to the rotation center axis Z of the sleeve portion 40. With this, the circlip 8 is well balanced under its expanded condition (see FIG. 10), thereby improving operability of a connection between the propeller shaft 1 and the rotating shaft 2, 3.

The first and second engaging portions 54, 55 of the circlip 8 are configured to have the small gaps C1 respectively between the first and second engaging portions 54, 55 and the second flat surfaces 44, 44 in a direction perpendicular to the rotation center axis Z (see FIGS. 6 and 8). With this, the production error of the circlip 8 and/or the sleeve portion 40 can be absorbed by the small gaps C1, thereby preventing poor assembly (engagement) of the circlip 8.

By the provision of the first and second through holes 41, 42, the retaining groove 26 on the outer peripheral side of the sleeve portion 40 is in fact constituted of a pair of retaining grooves 26a, 26b for retaining therein the circlip 8 (see FIG. 6). These retaining grooves 26a, 26b extend in the circumferential direction in a pair of regions each between the first and second through holes 41, 42 and are symmetrical with respect to the rotation center axis Z.

The circlip 8 is engaged and retained in the above-explained retaining grooves 26a, 26b, thereby preventing displacement of the circlip 8. By arranging the retaining grooves 26a, 26b at positions symmetrical with respect to the rotation center axis Z, it is possible to bring the circlip 8 into engagement from either side in the radial direction of the sleeve portion 40, thereby improving operability of a connection between the propeller shaft 1 and the rotating shaft 2, 3. For example, the circlip 8 shown in FIG. 8 may take a position upside down.

The retaining grooves 26a, 26b are formed on the outer peripheral side of the sleeve portion 40 to extend in the circumferential direction at positions away from the first and second through holes 41, 42 in the circumferential direction. Thus, it is possible to prevent displacement of the circlip 8 by fitting and retaining the circlip 8 in the retaining grooves 26a, 26b.

The sleeve portion 40 is formed on its inner peripheral side with the sealing abutment portion 40b on a side opposite to the insertion hole of the rotation shaft 2, 3 in the axial direction with respect to the first and second through holes 41, 42, and the sealing member 16 interposed between the rotation shaft 2, 3 and the sleeve portion 40 is brought into abutment with the sealing abutment portion 40b. Inner diameter D1 of the sealing abutment portion 40b is formed to be smaller than inner diameter D2 of the shaft fixing portion 40c at an axial position provided with the first and second through holes 41, 42 (see FIG. 5). By having the above-mentioned structure, it is possible to prevent damage of the sealing member 16 caused by hitting against edges of the through holes 41, 42 when the sealing member 16 passes the through holes 41, 42 during insertion of the rotation shaft 2, 3.

The sleeve portion 40 is formed on its outer periphery side with the boot attaching portion 37 for fixing the water-proof boot 36 surrounding the through holes 41, 42, at a position opposite to the insertion hole of the rotation shaft 2, 3 in the axial direction with respect to the through holes 41, 42 (see FIG. 7). With this structure, the through holes 41, 42 are surrounded by the water-proof boot 36, thereby preventing penetration of water, etc. through the through holes 41, 42.

It is configured that the circlip 8 except its first jig-engaging portions 56, 57 does not protrude from the outer peripheral surface 40d of the sleeve portion 40 (see FIGS. 8 and 13A). Thus, most of the circumferential region of the circlip 8 except its first jig-engaging portions 56, 57 does not protrude from the outer peripheral surface 40d of the sleeve portion 40. This is effective to make the propeller shaft small in size.

The first through hole 41 has the first side surfaces 41a, 41b (see FIG. 5), which are formed on both ends of the through hole 41 in the axial direction, parallel with each other, and perpendicular to the rotation center axis Z.

With this, it is possible to have surface contact between the first side surfaces 41a, 41b and an engaging portion (i.e., the arcuate portion X1) of the circlip 8 that is sandwiched therebetween. It is possible to make this engaging portion have a relatively large area to suppress stress concentration at the engaging portion of the circlip 8.

The circlip 8 is arcuate in shape and is formed on its both ends in the circumferential direction with the second jig-engaging portions 54b, 55b to be engaged with the jig 61 for retaining the circlip 8 in a diameter expanded condition (see FIG. 10).

With this structure, the circlip 8 in a diameter expanded condition by the jig 61 can be brought into a temporary engagement into the retaining groove 26 on the sleeve portion 40. Under this temporary engagement, the rotation shaft 2, 3 is inserted into the insertion hole 40a of the sleeve portion 40, and then the jig 61 is detached from the circlip 8 to cancel the diameter expanded condition, thereby achieving a connection between the propeller shaft 1 and the rotation shaft 2, 3. With this, it becomes unnecessary to have an operation of expanding the circlip or fitting the circlip 8 on the sleeve portion 40, when inserting the rotation shaft 2, 3, thereby improving operability of a connection between the propeller shaft 1 and the rotating shaft 2, 3.

As is seen from FIG. 3, in the joint J1, the inner race member 22 is provided with the sleeve portion 40 to receive the input shaft 2. In contrast, as is seen from FIG. 5, in the joint J2, the outer race member 31 is provided with the sleeve portion 40 to receive the output shaft 3. Thus, the present invention can applied to not only a propeller shaft having the sleeve portion 40 provided on the inner race member 22, but also a propeller shaft having the sleeve portion 40 provided on the outer race member 31.

### Second Embodiment

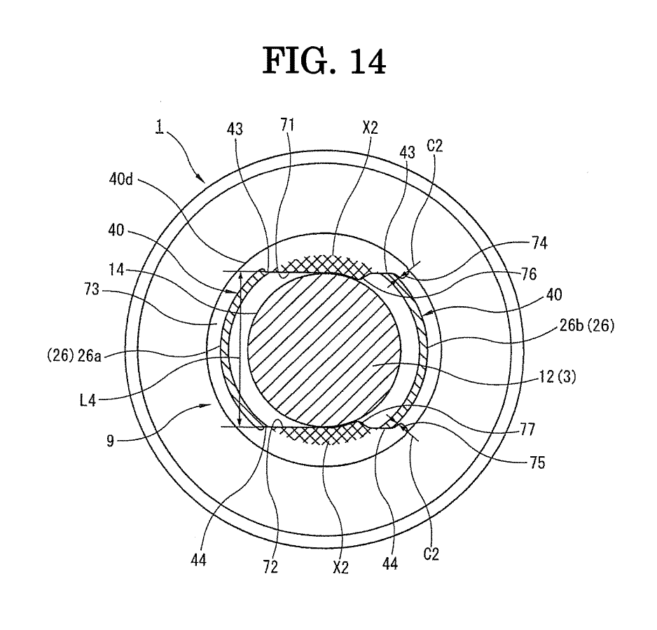

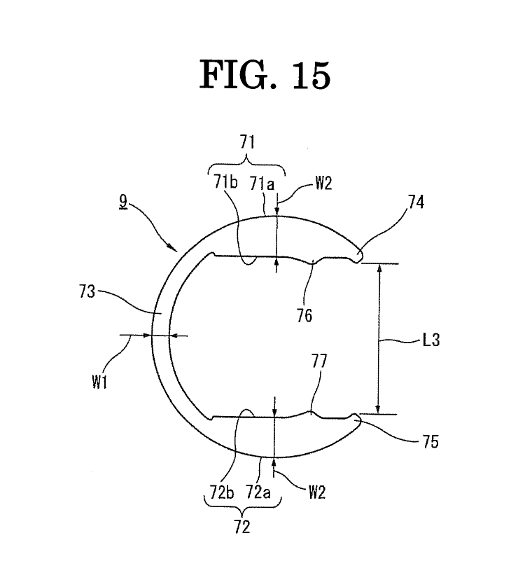

With reference to FIGS. 14 and 15, the second embodiment of a propeller shaft according to the present invention is described in the following. Except the shape of the circlip, basic structures of the second embodiment are similar to those of the first embodiment. Thus, similar parts and constructions are denoted by the same numerals, and their detailed explanations are omitted from the following description.

Similar to the circlip 8 of the first embodiment, a circlip 9 of the second embodiment is prepared by pressing a metal plate into an almost C-shape. The circlip 9 has (a) a first arm portion 71 that is formed in a straight line to be almost parallel with the first flat surfaces 43, 43 and is brought into engagement in the engaging groove 14 through the first through hole 41, (b) a second arm portion 72 that is formed in a straight line to be almost parallel with the second flat surfaces 44, 44 and is brought into engagement in the engaging groove 14 through the second through hole 42, (c) a connecting portion 73 that connects together the first and second arm portions 71, 72, (d) a first engaging portion 74 provided at one end in the circumferential direction of the first arm portion 71, and (e) a second engaging portion 75 provided at the other end in the circumferential direction of the second arm portion 72. The circlip 9 is configured that it does not protrude from the outer peripheral surface 40d of the sleeve portion 40 in a complete engagement condition of the circlip 9 in the retaining groove 26 of the sleeve portion 40. This is effective to make the propeller shaft small in size.

The first and second arm portions 71, 72 are respectively formed on their outer peripheral sides with arcuate surfaces 71a, 72a to be matched with the outer peripheral surface 40d of the sleeve portion 40 and on their inner peripheral sides with straight surfaces 71b, 72b to be along with the first and second flat surfaces 43, 44. In other words, in a condition that the circlip 9 is mounted on the sleeve portion 40 (see FIG. 14), these straight surfaces 71b, 72b of the circlip 9 may be respectively defined as being substantially parallel with a first imaginary line extending between the first flat surfaces 43, 43 and a second imaginary line extending between the second flat surfaces 44, 44, and these first and second imaginary lines may be parallel with each other (see FIG. 6). The circlip 9 is configured such that, after its complete engagement, the circlip 9 projects at its first and second arm portions 71, 72 toward the inner peripheral side of the sleeve portion 40 through the first and second through holes 41, 42 respectively and is overlapped or engaged at its two meshed portions X2, X2 with a side wall 14a of the engaging groove 14, thereby retaining the output shaft 3.

The connection portion 73 is formed such that a thickness W1 in the radial direction is almost constant in the circumferential direction and is smaller than thickness W2 of the first and second arm portions 71, 72 in the radial direction. In other words, each of the first and second arm portions 71, 72, which receives shear force, is configured to have a large thickness W2, thereby relaxing stress concentration at the first and second arm portions 71, 72. In contrast, the connecting portion 73 is not required to have a high rigidity, as compared with the first and second arm portions 71, 72. Thus, the connecting portion 73 is configured to have a small thickness W1. This is effective to make the propeller shaft small in size.

The first and second engaging portions 74, 75 at tips of the first and second arm portions 71, 72 project inwardly to have inner peripheral surfaces corresponding to both ends of the retaining groove 26b in the circumferential direction.

The first and second engaging portions 74, 75 has a distance L3 therebetween that is shorter than the distance L4 between the first and second flat surfaces 43, 44. With this, the first and second engaging portions 74, 75 are brought into a secure engagement with the bottom surface of the retaining groove 26b, thereby preventing dropping of the circlip 9.

Under this engagement, the first and second engaging portions 74, 75 are respectively spaced from the first and second flat surfaces 43, 44 to have small gaps C2, C2.

The first and second arm portions 71, 72 are respectively formed at their middle positions with third engaging portions 76, 77 that project inwardly and are brought into engagement with the bottom surface of the engaging groove 14 of the output shaft 3 when the circlip 9 is in the engagement condition. That is, each of the third engaging portions 76, 77 is formed at its region on the side of the connecting portion 73 with a curved surface having a shape corresponding to the outer peripheral surface of the output shaft 3. Therefore, when the first and second engaging portions 74, 75 are in engagement with the bottom surface of the retaining groove 26b of the sleeve portion 40, each of the third engaging portions 76, 77 is in engagement with the bottom surface of the engaging groove 14 of the output shaft 3.

The circlip 9 is fitted from the side into the retaining groove 26b of the sleeve portion 40 in a manner that the straight surfaces 71b, 72b of the circlip 9 are respectively parallel or aligned with the first and second flat surfaces 43, 44 (i.e., the first and second imaginary lines respectively extending between the first flat surfaces 43, 43 and between the second flat surfaces 44, 44) after a proper engagement of the output shaft 3 into the insertion hole 40a of the sleeve portion 40.

Specifically, when the circlip 9 is fitted from the left side into the retaining groove 26 (see FIG. 14), the first and second engaging portions 74, 75 and then the third engaging portions 76, 77 ride over the first and second flat surfaces 43, 44 on the left side, and then the third engaging portions 76, 77 move along the bottom surface of the engaging groove 14. When the connecting portion 73 is brought into abutment with the bottom surface of the retaining groove 26a, the first and second engaging portions 74, 75 pass the first and second flat surfaces 43, 44 on the right side and brought into engagement with both ends of the retaining groove 26b, thereby fixing the circlip 9 on the sleeve portion 40.

As mentioned above, the present embodiment provides advantageous effects similar to those of the first embodiment. Besides, particularly in the present embodiment, it is possible to have a large overlapped area by the two meshed portions X2, X2 (see FIG. 14), as compared with the single meshed portion X1 (see FIG. 8) in the first embodiment. Therefore, it is possible to more effectively retain the output shaft 3 by the circlip 9 in the present embodiment.

In the present embodiment, it is possible to more smoothly fit the circlip 9 into the retaining groove 26 by sliding the straight surfaces 71b, 72b on the first and second flat surfaces 43, 44, as compared with the first embodiment.

The present invention is not limited to construction of the above-mentioned embodiment. The embodiment may be freely changed depending on the specification of an applied object, the cost, etc.

In the above-mentioned embodiments, as a connection structure of the propeller shaft 1, there was exemplarily described a connection between the second constant-velocity joint J2 and the output shaft 3. This connection can similarly be applied to a connection between the first constant-velocity join J1 and the input shaft 2.

In the above-mentioned embodiments, the present invention was exemplarily applied to a constant-velocity joint. Besides such constant-velocity joint, it may be applied to other joints, such as rubber coupling and Cardan joint.

The entire contents of basic Japanese Patent Application No. 2016-145148 (filed Jul. 25, 2016) of the application, of which priority is claimed, are incorporated herein by reference.

What is claimed is:

1. A propeller shaft that is provided between a driving source and a driving wheel of a vehicle to transmit rotation of the driving source to the driving wheel, the propeller shaft comprising:
a shaft portion interposed between a first shaft on a side of the driving source and a second shaft on a side of the driving wheel;
a joint portion provided between the shaft portion and a rotating shaft that is one of the first and second shafts;
a sleeve portion that is provided at the joint portion and has an inner peripheral side for receiving therein the rotating shaft;
a through hole that is formed through a circumferential range of a portion of the sleeve portion, the through hole being opposed in a radial direction of the sleeve portion to an engaging groove formed on an outer peripheral side of the rotating shaft in a condition that the sleeve portion receives therein the rotating shaft on the inner peripheral side of the sleeve portion; and
a circlip provided on an outer peripheral side of the sleeve portion, the circlip being engaged in the engaging groove of the rotating shaft through the through hole of the sleeve portion.

2. The propeller shaft as claimed in claim 1, wherein the through hole comprises first and second through holes that are spaced from each other in a circumferential direction of the sleeve portion.

3. The propeller shaft as claimed in claim 2, wherein the first and second through holes are positioned to be symmetrical with respect to a rotation center axis of the sleeve portion.

4. The propeller shaft as claimed in claim 3, wherein the sleeve portion comprises (a) a pair of first flat surfaces that are defined at both ends of the first through hole in a circumferential direction of the rotation center axis and (b) a pair of second flat surfaces that are defined at both ends of the second through hole in the circumferential direction of the rotation center axis,
wherein a first imaginary line extending between the first flat surfaces is parallel with a second imaginary line extending between the second flat surfaces,
wherein, in a condition that the circlip is mounted on the sleeve portion, the circlip comprises:
a first arm portion having a straight surface that is substantially parallel with the first imaginary line and being engaged in the engaging groove through the first through hole; and
a second arm portion having a straight surface that is substantially parallel with the second imaginary line and being engaged in the engaging groove through the second through hole.

5. The propeller shaft as claimed in claim 4, wherein the circlip further comprises a connecting portion that connects one end of the first arm portion and one end of the second arm portion in the circumferential direction, a first engaging portion provided at another end of the first arm portion, and a second engaging portion provided at another end of the second arm portion,
wherein a distance between the first and second engaging portions is shorter than a distance between the first and second imaginary lines.

6. The propeller shaft as claimed in claim 5, wherein, in the condition that the circlip is mounted on the sleeve portion, each of the first and second engaging portions is spaced away from the sleeve portion in a radial direction of the rotation center axis.

7. The propeller shaft as claimed in claim 3, wherein the sleeve portion is formed at an outer peripheral side thereof with a pair of retaining grooves for retaining the circlip therein,
wherein, in the circumferential direction of the sleeve portion, the retaining grooves extend in a pair of regions each being between the first and second through holes and are symmetrical with respect to the rotation center axis.

8. The propeller shaft as claimed in claim 2, wherein the circlip comprises first and second arm portions that are respectively inserted into the first and second through holes and a connecting portion that connects together the first and second arm portions,
wherein, in a radial direction of the sleeve portion, the connecting portion is smaller than each of the first and second arm portions in thickness.

9. The propeller shaft as claimed in claim 8, wherein, in a condition that the circlip is mounted on the sleeve portion, the circlip is configured such that the circlip does not protrude from an outer peripheral surface of the sleeve portion.

10. The propeller shaft as claimed in claim 1, wherein the sleeve portion is formed on an outer peripheral side thereof with a retaining groove for retaining therein the circlip, the retaining groove being at a position that is away from the through hole in a circumferential direction of the sleeve portion.

11. The propeller shaft as claimed in claim 1, wherein the rotating shaft is formed on an outer periphery thereof with a sealing member that is interposed between the rotating shaft and the sleeve portion when the rotating shaft is received in the sleeve portion,
wherein the sleeve portion is formed on an inner peripheral side thereof with a sealing abutment surface for an abutment of the sealing member thereon, the sealing abutment surface being on a side opposite to an insertion hole of the rotation shaft in an axial direction of the sleeve portion with respect to the through hole,
wherein an inner diameter of the sealing abutment surface is smaller than an inner diameter of the sleeve portion at a position in the axial direction where the through hole is provided.

12. The propeller shaft as claimed in claim 1, wherein the propeller shaft further comprises a cover member that surrounds the through hole, and the sleeve portion is formed at an outer peripheral side thereof with a cover attaching portion for fixing the cover member, the cover attaching portion being on a side opposite to an insertion hole of the rotation shaft in an axial direction of the sleeve portion with respect to the through hole.

13. The propeller shaft as claimed in claim 1, wherein, in a condition that the circlip is mounted on the sleeve portion, the circlip is configured such that the circlip does not protrude from an outer peripheral surface of the sleeve portion.

14. The propeller shaft as claimed in claim 1, wherein the through hole has a pair of side surfaces for interposing therebetween the circlip, the side surfaces being formed on both end sides of the sleeve portion in an axial direction thereof, being parallel with each other and being perpendicular to a rotation center axis of the sleeve portion.

15. The propeller shaft as claimed in claim 1, wherein the circlip is arcuate in shape and comprises a pair of jig-engaging portions at both ends of the circlip in a circumferential direction thereof, the circlip being maintained in a diameter expansion condition by engaging a jig with the jig-engaging portions.

16. The propeller shaft as claimed in claim 1, wherein the joint portion comprises:
an outer race portion provided at the shaft portion;
an inner race member provided on an inner peripheral side of the outer race portion;
a plurality of balls interposed between the outer race portion and the inner race member;
a first ball engaging portion that is provided on an inner peripheral side of the outer race portion along an axial direction of the shaft portion and is engaged with the balls to limit a relative rotation between the balls and the outer race portion in a circumferential direction of the sleeve portion; and
a second ball engaging portion that is provided on an outer peripheral side of the inner race member along an axial direction of the shaft portion and is engaged with the balls to limit a relative rotation between the balls and the inner race member in the circumferential direction of the sleeve portion,
wherein the sleeve portion is provided on the inner race member.

17. The propeller shaft as claimed in claim 1, wherein the joint portion comprises:
an inner race portion provided at the shaft portion;
an outer race member provided on an outer peripheral side of the inner race portion;
a plurality of balls interposed between the inner race portion and the outer race member;
a first ball engaging portion that is provided on an inner peripheral side of the outer race member along an axial direction of the shaft portion and is engaged with the balls to limit a relative rotation between the balls and the outer race member in a circumferential direction of the sleeve portion; and
a second ball engaging portion that is provided on an outer peripheral side of the inner race portion along an axial direction of the shaft portion and is engaged with the balls to limit a relative rotation between the balls and the inner race portion in the circumferential direction of the sleeve portion,
wherein the sleeve portion is provided on the outer race member.
